(19) United States
(12) Patent Application Publication
(10) Pub. No.: US 2017/0102077 A1
(43) Pub. Date: Apr. 13, 2017

(54) VARIABLE AREA FLOW RESTRICTION

(71) Applicant: EMERSON PROCESS MANAGEMENT REGULATOR TECHNOLOGIES, INC., McKinney, TX (US)

(72) Inventors: Madhusudhan Reddy Kotragouda Basappa, Frisco, TX (US); Mark A. Michnevitz, Frisco, TX (US); Jake Buford, The Colony, TX (US)

(21) Appl. No.: 15/291,595

(22) Filed: Oct. 12, 2016

Related U.S. Application Data
(60) Provisional application No. 62/240,394, filed on Oct. 12, 2015.

(51) Int. Cl. F16K 1/52

(52) U.S. Cl. CPC F16K 1/52

(57) ABSTRACT

A fluid flow valve includes a valve body, a loading chamber disposed within the valve body, a valve assembly, and a restrictor unit. The valve body defines a flow inlet, a flow outlet, and a loading chamber inlet. The loading chamber is coupled to the loading chamber inlet. The valve assembly is at least partially disposed between the flow inlet and the flow outlet and is in communication with the loading chamber. The valve assembly is adapted to cooperate with the loading chamber adjust fluid flow at the flow outlet by adjusting a fluid flow rate between the flow inlet and the flow outlet. The restrictor unit is at least partially disposed within the loading chamber inlet. The loading chamber and the valve assembly are adapted to be responsive to a change in loading pressure to achieve a modified fluid flow rate. The restrictor unit is adapted to adjust a response speed in which the modified fluid flow rate is achieved.

### CROSS REFERENCE TO RELATED APPLICATIONS

This application claims the benefit of U.S. Provisional Application No. 62/240,394 (filed on Oct. 12, 2015). The entirety of the foregoing provisional application is incorporated by reference herein.

### FIELD OF THE DISCLOSURE

The present disclosure generally relates to fluid flow valves and, more particularly, to apparatuses which adjust a speed in which a fluid flow valve responds to a change in operating pressure.

### BACKGROUND

Industrial processing plants use valves in a wide variety of applications such as, for example, controlling the flow of a fluid (e.g., a gas, a liquid, and the like) in a processing operation. The regulation of the flow of fluids requires a valve provide and maintain a specified flow rate until the fluid flow system requires the valve operate at a different flow rate.

Due to the instability of certain types of valves at particular flow rates, the speed in which the valve responds to the change in flow rates and/or desired pressures may be unsuitably fast or slow for proper operation of the valve. As such, the valve may perform at a reduced accuracy during subsequent flow conditions, and may ultimately lead to damage of the valve. Dampers and restrictors have been used to limit the speed in which the valve responds to the change in flow rates, but these components oftentimes require a skilled technician to manually open and adjust the restrictor to increase the inlet flow. These restrictors and dampers oftentimes include complicated, costly componentry and may be prone to serviceability issues.

### SUMMARY

Generally speaking, pursuant to these various embodiments, systems and approaches for variable area restriction are provided and may include a valve body, a loading chamber disposed within the valve body, a valve assembly, and a restrictor unit. The valve body defines a flow inlet, a flow outlet, and a loading chamber inlet. The loading chamber is coupled to the loading chamber inlet.

The valve assembly is at least partially disposed between the flow inlet and the flow outlet and is in communication with the loading chamber. The valve assembly is adapted to cooperate with the loading chamber to adjust fluid flow at the flow outlet by adjusting a fluid flow rate between the flow inlet and the flow outlet. The restrictor unit is at least partially disposed within the loading chamber inlet. The loading chamber and the valve assembly are adapted to be responsive to a change in loading pressure such that a modified fluid flow rate is achieved. The restrictor unit is adapted to adjust a response speed in which the modified fluid flow rate is achieved.

In some approaches, the restrictor unit comprises a tapered screw having a plurality of response speed adjustments. In other approaches, the restrictor unit comprises a cylindrical ziggurat. The restrictor unit may further comprise a threaded element adapted to be threadably inserted into the loading chamber inlet.

In some forms, when the loading pressure changes, the loading chamber is adapted to experience a change in pressure. This change in pressure may in turn cause the valve assembly to cause the modified rate to be achieved.

The fluid flow valve may further include a loading chamber flow path which extends between the loading chamber and the loading chamber inlet. In these examples, the restrictor unit is adapted to be at least partially disposed within the loading chamber flow path to adjustably restrict a loading chamber flow path rate of fluid propagating the loading chamber flow path.

In other forms, an apparatus for adjusting a flow rate of a valve loading chamber may include a restrictor unit adapted to be at least partially disposed I n a valve inlet and a valve flow channel. The restrictor unit may comprise an elongated body extending along a central longitudinal axis and may have a cross section wherein a cross-sectional dimension decreases along the length of the elongated body. When the restrictor unit is inserted into the valve inlet, the restrictor unit restricts an amount of flow propagating the valve flow channel based on a depth in which the restrictor unit is inserted into the valve inlet.

In some approaches, the restrictor unit includes a threaded portion to threadably couple the restrictor unit to the valve inlet. In some embodiments, a profile of the elongated body forms a generally stepped patter. In other embodiments, a profile of the elongated body forms a linear or an arcuate pattern or a combination of a linear and an arcuate pattern.

So configured, the restrictor unit may be utilized in any pressure loaded valve to control the response speed by being inbuilt into the flow path of the loading pressure. Due to the tapered design of the restrictor unit, flow may be uniformly controlled. Because the flow-controlling features of the restrictor unit are on the outer profile of the restrictor screw, the restrictor screw may be easily inspected and assembled to ensure the variable area affect may be achieved. The restrictor unit may replace dampers and flow restrictors commonly used to provide for a reduced component failure rate and easier adjustability.

### BRIEF DESCRIPTION OF THE DRAWINGS

The above needs are at least partially met through provision of the variable area flow restriction approaches described in the following detailed description, particularly when studied in conjunction with the drawings, wherein:

FIG. 1 comprises a cross-sectional view of an adjustable fluid flow rate valve in accordance with various embodiments of the invention; and

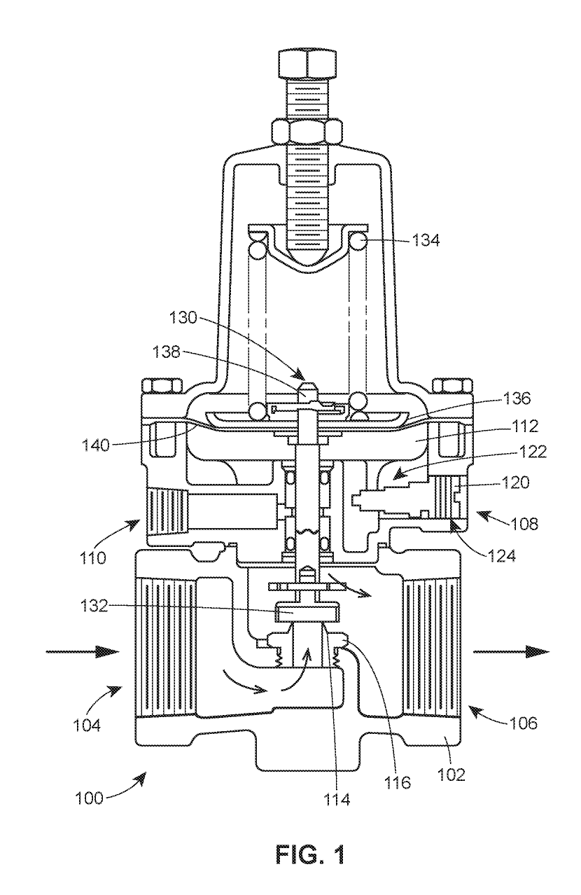

FIG. 2 comprises a cross-sectional view of a detailed restrictor unit of the adjustable fluid flow rate valve of FIG. 1 in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Referring now to the drawings, a fluid flow valve 100 is provided. In some of these examples, the valve 100 may be a failed closed, a failed open valve, or any other classification of valve and/or regulator depending on a particular orientation of the valve's components. Thus, it will be appreciated that while the examples provided herein refer to a failed open valve, similar strategies and approaches may be incorporated in a failed open valve or any other type of apparatus. The valve 100 has a valve body 102 which defines a flow inlet 104, a flow outlet 106, and a loading chamber inlet 108, an atmospheric pressure inlet 110, a loading chamber 112 disposed within the valve body 102 and coupled to the loading chamber inlet 108, a valve assembly 130 at least partially disposed between the flow inlet 104 and the flow outlet 106 and in communication with the loading chamber 112 to adjust fluid flow at the flow outlet 106 by adjusting a fluid flow rate between the flow inlet 104 and the flow outlet 106, and a restrictor unit 120 at least partially disposed within the loading chamber inlet 108. It is understood that additional components such as valve stems, coupling mechanisms, and the like may be disposed within the valve 100 for proper operation thereof and are known by those having skill in the art and will not be discussed in detail for the sake of brevity.

The loading chamber 112 and the valve assembly 130 are adapted to be responsive to a change in loading pressure such that a modified rate is achieved. The restrictor unit 120 is adapted to adjust a response speed in which the modified rate is achieved.

The valve 100 may further include a valve seat 114 at a valve passage 116 and a valve member 132 of the valve assembly 130. The valve member 132 is urged toward contact with the valve seat 114 by a resilient member 134 (e.g., a spring) contained in the loading chamber 112. The resilient member 134 engages a plate 136 operably coupled to a stem 138 which is in turn operably coupled to the valve member 132.

When the loading pressure received at the loading chamber inlet 108 is at a steady-state value, the pressure in the loading chamber 112 is also at a steady-state value. The resilient member 134 exerts a force equal to the pressure within the loading chamber 112 to maintain the valve member 132 in an equalized position relative to the valve seat 114. As such, fluid flow between the chamber inlet 104 and the chamber outlet 106 is at a constant rate.

When the loading pressure received at the loading chamber inlet 108 changes, the pressure at the loading chamber 112 also changes and causes the resilient member to adjust to exert an adjusted force equal to the pressure within the loading chamber 112. As a result, the valve member 132 is repositioned and fluid flow between the chamber inlet 104 and the chamber outlet 106 is at a different rate.

As an example, when there is an increase in the load pressure at the loading chamber inlet 108, pressure in the loading chamber 112 increases which causes a diaphragm 140 to move upwards and exert a force against the plate 136 which causes the resilient member 134 to compress. Accordingly, the valve member 132 moves away from the valve seat 114 to increase the fluid flow from the chamber inlet 104 to the chamber outlet 106 Similarly, a reduction in load pressure at the loading chamber inlet 108 causes the pressure in the loading chamber 112 to decrease which causes the diaphragm 140 to move downwards, causing the resilient member 134 to extend and thereby moving the plate 136 and the valve member 132 towards the valve seat 114 to decrease the fluid flow from the chamber inlet 104 to the chamber outlet 106.

The restrictor unit 120 is disposed within the loading chamber inlet 108 to adjust the speed in which the loading chamber 112 experiences a change in pressure. The restrictor unit 120 may include any number of steps, tapers, or levels 122, and may resemble a tapered screw or a cylindrical ziggurat. Each taper, step, or level 122 provides for a different response speed adjustment. It is understood that other shapes and configurations of the restrictor unit 120 may be envisioned (e.g., conical, prismatic, and the like). For example, the restrictor unit 120 may include an angular taper 120 which decreases along the length of the unit 120, may have a curved (e.g., parabolic) longitudinal length, or any other suitable profile. As a result, any different cross-sectional diameter along a longitudinal length of the restrictor unit 120 will provide for a different response speed.

The restrictor unit 120 may also include a threaded connection 124 having any suitable pitch which corresponds to a threaded connection of the loading chamber inlet 108. As such, the restrictor unit may be threadably inserted into the loading chamber inlet 108 to adjust the flow entering the loading chamber 112 via the use of a device such as a screwdriver inserted into a notch 126 at the end of the restrictor unit 120. The restrictor unit 120 may further include any number of sealing mechanisms 128 such as o-rings which create a seal between an outer surface of the restrictor unit 120 and the loading chamber inlet 108. In some examples, the restricting member may be friction fit into the loading chamber inlet 108. In some examples, the restrictor unit 120 may include a channel extending the length of the restrictor unit 120 to allow an amount of fluid to flow between the loading chamber inlet 108 and the loading chamber 112.

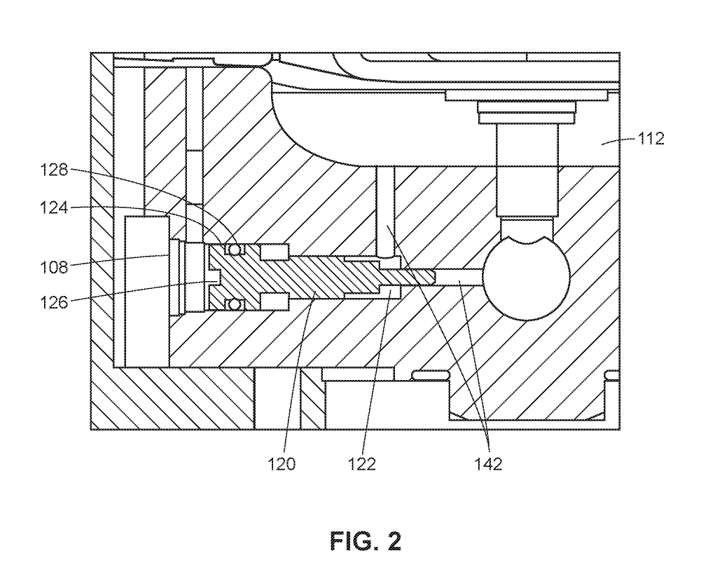

As illustrated by FIG. 2,the restrictor unit 120 is disposed to at least partially restrict flow between any number of loading chamber flow paths 142 from the loading chamber inlet 108 to the loading chamber 112. In some examples, the restrictor unit 120 is adapted to be at least partially disposed within the loading chamber flow path 142 to adjustably restrict a loading chamber flow path flow rate of fluid propagating the loading chamber flow path. In other words, depending on the position of the restrictor unit 120 within the loading chamber inlet 108, a different taper or step 108 is disposed within the flow path 142. As the cross-sectional diameter of the portion of the restrictor unit 120 being disposed within the loading chamber flow path 142 increases, the loading chamber flow path rate decreases due to the open volume of the flow path decreasing. As a result, the rate in which the loading chamber 112 receives the load pressure may be varied or controlled.

Because the outer profile of the restrictor unit 120 contains the adjustable restricting surfaces, the unit may easily be inspected to ensure there is no damage. Further, because the flow rate adjustment is encapsulated within the restrictor unit 120, there is no need for complex arrangements and/or structures.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A fluid flow valve comprising:
a valve body defining a flow inlet, a flow outlet, and a loading chamber inlet;
a loading chamber disposed within the valve body and coupled to the loading chamber inlet;
a valve assembly at least partially disposed between the flow inlet and the flow outlet and in communication with the loading chamber, the valve assembly adapted to cooperate with the loading chamber to adjust fluid flow at the flow outlet by adjusting a fluid flow rate between the flow inlet and the flow outlet; and
a restrictor unit at least partially disposed within the loading chamber inlet;
wherein the loading chamber and the valve assembly are adapted to be responsive to a change in loading pressure such that a modified rate is achieved, wherein the restrictor unit is adapted to adjust a response speed in which the modified rate is achieved.

2. The fluid flow valve of claim 1, wherein the restrictor unit comprises a tapered screw having a plurality of response speed adjustments.

3. The fluid flow valve of claim 2, wherein the restrictor unit further comprises a threaded element adapted to be threadably inserted into the loading chamber inlet.

4. The fluid flow valve of claim 4, wherein upon the loading pressure changing, the loading chamber is adapted to experience a change in pressure which causes the valve assembly to cause the modified rate to be achieved.

5. The fluid flow valve of claim 1, further comprising a loading chamber flow path extending between the loading chamber and the loading chamber inlet, wherein the restrictor unit is adapted to be at least partially disposed within the loading chamber flow path to adjustably restrict a loading chamber flow path flow rate of fluid propagating the loading chamber flow path.

6. The fluid flow valve of claim 1, wherein the restrictor unit comprises a cylindrical ziggurat having a threaded portion.

7. The fluid flow valve of claim 1, further comprising a diaphragm at least partially disposed within the loading chamber, wherein the diaphragm is adapted to move in response to the change in loading pressure to equalize the pressure in the loading chamber with a force exerted by a resilient member.

8. The fluid flow valve of claim 2, wherein the restrictor unit includes an outer seal for sealing the restrictor unit within the loading chamber inlet.

9. An apparatus for adjusting a flow rate of a valve loading chamber comprising:
a restrictor unit adapted to be at least partially disposed in a valve inlet and a valve flow channel, the restrictor unit comprising an elongated body extending along a central longitudinal axis, the restrictor unit having a cross-section wherein a cross-sectional dimension decreases along the length of the elongated body, wherein when the restrictor unit is inserted into the valve inlet, the restrictor unit restricts an amount of flow propagating the valve flow channel based on an insertion depth.

10. The apparatus of claim 9, wherein the restrictor unit includes a threaded portion to threadably couple the restrictor unit to the valve inlet.

11. The apparatus of claim 9, wherein a profile of the elongated body forms a generally stepped pattern.

12. The apparatus of claim 9, wherein a profile of the elongated body forms a linear or an arcuate pattern or a combination thereof.
